(19) United States
(12) Patent Application Publication
(10) Pub. No.: US 2013/0221923 A1
(43) Pub. Date: Aug. 29, 2013

(54) UNIVERSAL CHARGING SYSTEM AND BATTERY PACK FOR VIDEO GAME CONTROLLERS

(71) Applicant: Paul A. Robertson, Seattle, WA (US)

(72) Inventor: Paul A. Robertson, Seattle, WA (US)

(73) Assignee: WHALEN FURNITURE MANUFACTURING INC., San Diego, CA (US)

(21) Appl. No.: 13/403,589

(22) Filed: Feb. 23, 2012

(51) Int. Cl. H02J 7/00; H01M 2/10

(52) U.S. Cl. 320/112; 429/98

(57) ABSTRACT

An interchangeable battery pack system for video game controllers is disclosed. The battery pack configured and arranged for insertion into a battery compartment of a video game controller. The battery pack has a bottom surface with a recess formed therein. The battery pack has a first set of battery electrical contacts for engagement with the electrical contacts of the video game controller and a second set of battery electrical contacts for charging the battery pack. A battery pack adapter cover is also included and is configured and arranged to releasably attach to the battery pack. The battery pack adapter cover has an aperture therethrough exposing the bottom surface of the battery pack when attached thereto. The battery pack adapter cover has mating formation thereon configured and arranged to releasably attach to a battery compartment of a video game controller for a video game system.

### BACKGROUND OF THE INVENTION

1. Field of the Invention

The present patent document relates generally to video game systems and controllers and more particularly to a universal charging system and battery pack for wireless video game controllers

2. Background of the Related Art

Many households have multiple video game systems, such as the Nintendo Wii, Microsoft Xbox, and Sony PlayStation brand video game system. These video games systems have one or more wireless video game controllers that players use to play the video game systems with.

Because the game controllers are wireless they operate on battery power. Players must, therefore, ensure the game controller battery is adequately charged prior to playing the video game system to have an enjoyable experience. A game controller with a weak battery can cause unresponsive play, leading to frustration of the player.

Many households, though, have multiple video game systems, which leads to the problem of having multiple wireless game controllers that all require having adequately charged batteries.

Accordingly, there is a need in the art for a method and system of ensuring multiple different brand video game controllers have adequately charged batteries

### SUMMARY OF THE INVENTION

The universal charging system and battery pack for video game controllers solves the problems of the prior art by providing a charging station that can hold and charge multiple video game controllers. The universal battery pack provided is configured to mount within multiple different brand controllers via an adapter cover, which replaces the standard battery cover on the video game controller. The battery pack is configured and arranged to be recharged by the charging station without removal of the battery pack from the game controller.

### BRIEF DESCRIPTION OF THE DRAWINGS

These and other features, aspects, and advantages of the present invention will become better understood with reference to the following description, appended claims, and accompanying drawings where:

FIG. 1A is a perspective view of a charging station;

FIG. 1B is side elevation view of a charging station

FIG. 1C is a top view of a charging station;

FIG. 1D is an end view of a charging station;

FIG. 2A is a top front perspective view of a battery pack;

FIG. 2B is an exploded view of a battery pack;

FIG. 2C is a right side view of a battery pack;

FIG. 2D is a front view of a battery pack;

FIG. 2E is a left side view of a battery pack;

FIG. 2F is a top view of a battery pack;

FIG. 2G is a rear view of a battery pack;

FIG. 2H is a bottom view of a battery pack;

FIG. 3 is a perspective view of a battery pack docked in the charging station;

FIG. 4 is a perspective view of a Sony brand video game controller docked in the charging station;

FIG. 5A is a partially exploded bottom perspective view of a Nintendo brand video game controller showing the battery pack and a battery pack adapter cover;

FIG. 5B is a bottom perspective view of a Nintendo brand video game controller showing the battery pack and a battery pack adapter cover assembled together;

FIG. 6 is a perspective view of a Nintendo brand video game controller docked in the charging station;

FIG. 7A is a perspective view of a battery pack adapter cover configured for a Nintendo brand video game controller;

FIG. 7B is a top view of a battery pack adapter cover configured for a Nintendo brand video game controller;

FIG. 7C is a bottom view of a battery pack adapter cover configured for a Nintendo brand video game controller;

FIG. 7D is a rear view of a battery pack adapter cover configured for a Nintendo brand video game controller;

FIG. 7E is a left side view of a battery pack adapter cover configured for a Nintendo brand video game controller;

FIG. 8A is a partially exploded view of a Microsoft brand video game controller showing the battery pack a battery pack adapter cover;

FIG. 8B is a bottom perspective view of a Microsoft brand video game controller showing the battery pack a battery pack adapter cover assembled together;

FIG. 9 is a perspective view of a Microsoft brand video game controller docked in the charging station;

FIG. 10A is a perspective view of a battery pack adapter cover configured for a Microsoft brand video game controller;

FIG. 10B is a top view of a battery pack adapter cover configured for a Microsoft brand video game controller;

FIG. 10C is a bottom view of a battery pack adapter cover configured for a Microsoft brand video game controller;

FIG. 10D is a front view of a battery pack adapter cover configured for a Microsoft brand video game controller; and

FIG. 10E is a right side view of a battery pack adapter cover configured for a Microsoft brand video game controller.

### DESCRIPTION OF THE PREFERRED EMBODIMENT

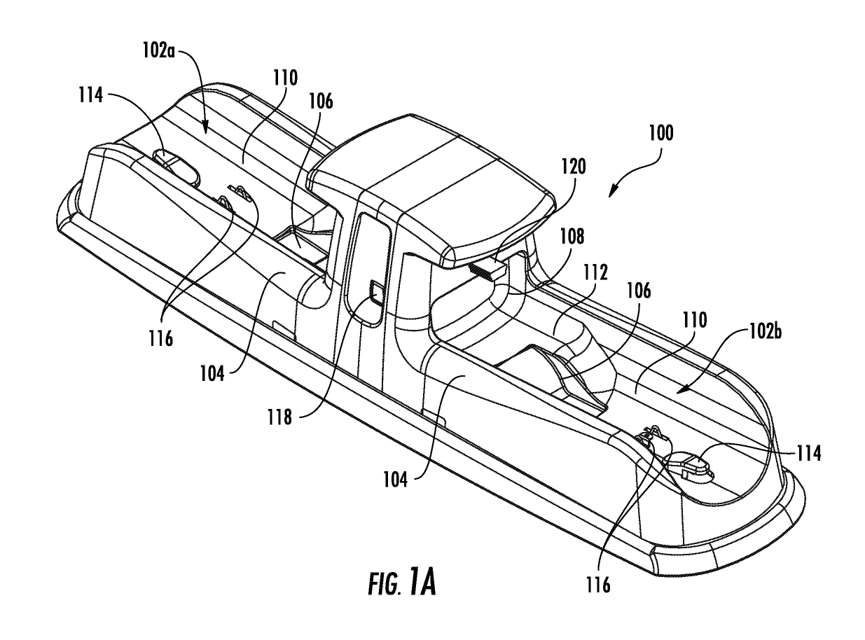

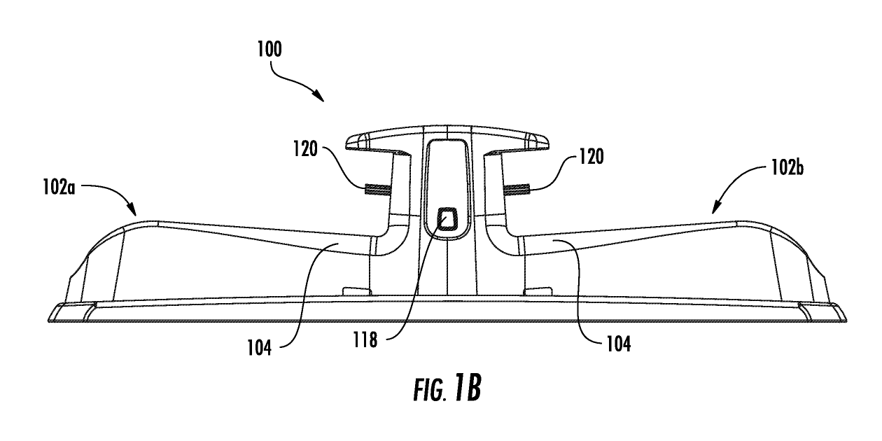

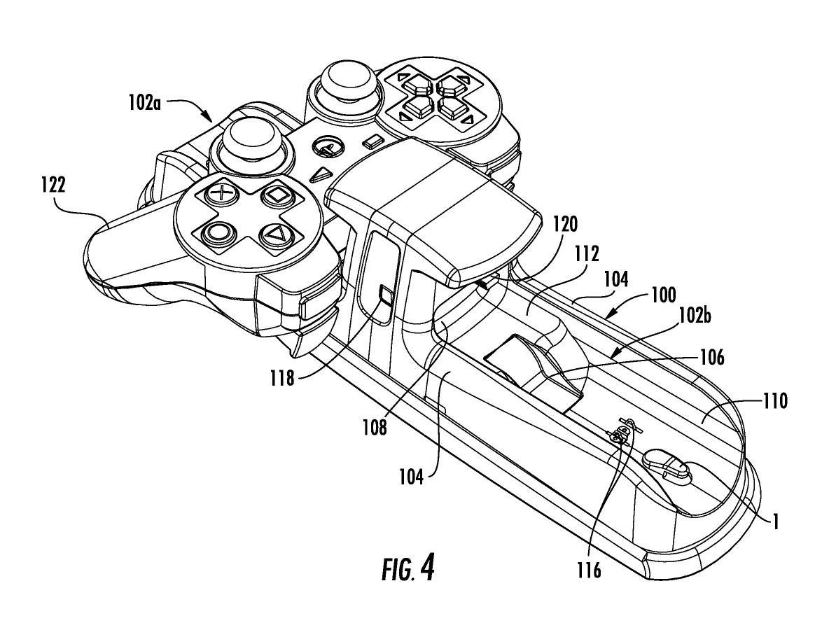

Referring now to FIGS. 1A-1D, the charging station is shown generally at 100. The charging station 100 includes two cradles 102a, 102b contoured to receive a number of different brand video game controllers 122, 300, 400 (Best seen in FIGS. 4, 6, and 9). The contoured surface of each cradle 102a,102b includes a number of sloped sides 104 and recesses 106, 108, 110, 112 to accommodate the shapes of the different brand video game controllers 122, 300, 400.

In the bottom of the cradle 102a, 102b, a raised boss 114 extends upwards. The boss 114 is shaped and contoured for mating engagement with a recess formed on the battery pack 200, described further below. Forward of the raised boss 114 are a number of electrical contacts 116 configured and arranged to engage the battery electrical contacts on the battery pack 200 when placed in the cradle 102a, 102b.

The charging station 100 further includes a power adapter (not shown) which supplies power to the charging station 100 to charge the battery pack 200. The charging station 100 may be equipped with a charging circuit to prevent overcharging of the battery pack 200, as is known in the art and need not be described in detail herein. If included, the charging circuit may also include an indicator 118 to show to the user that the battery pack 200 is finished charging.

The charging station 100 also includes a charging connector 120 to charge video game controllers that have integral rechargeable batteries. The charging connector 120, such as a mini USB connector and the like.

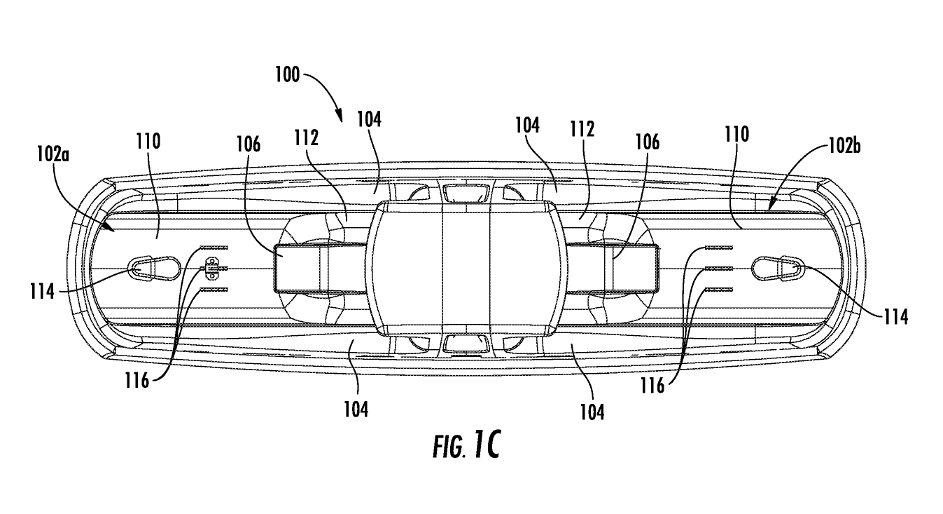

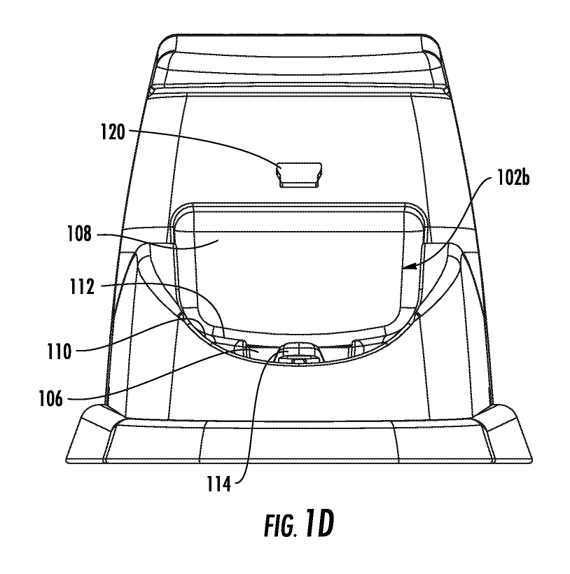

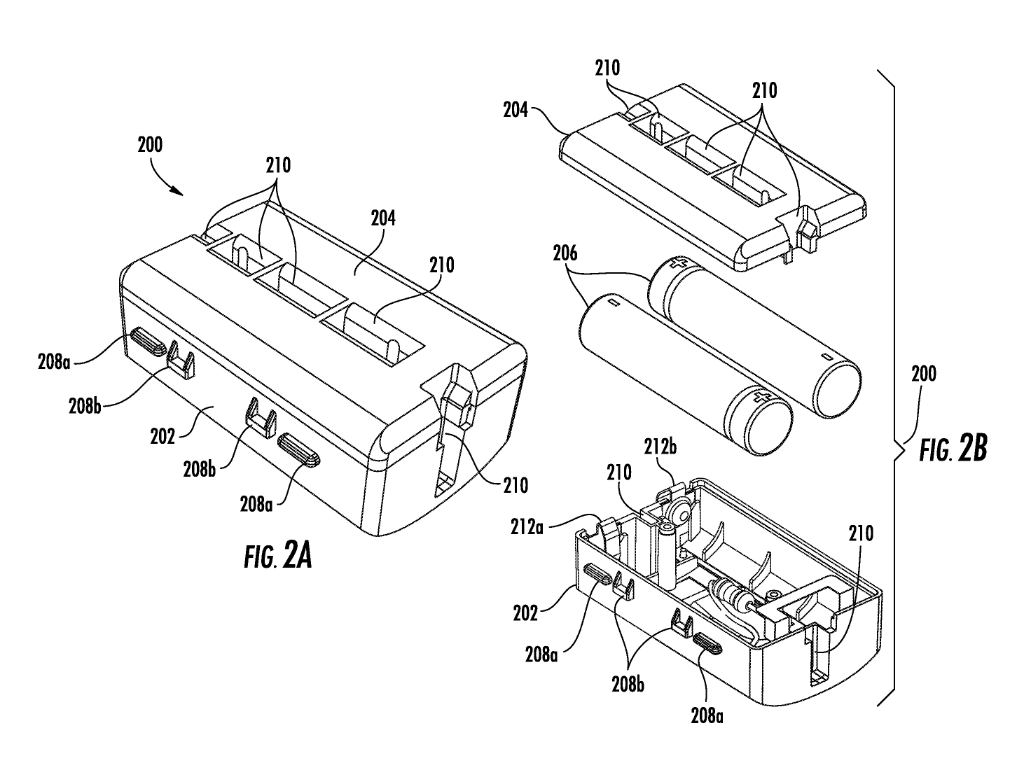

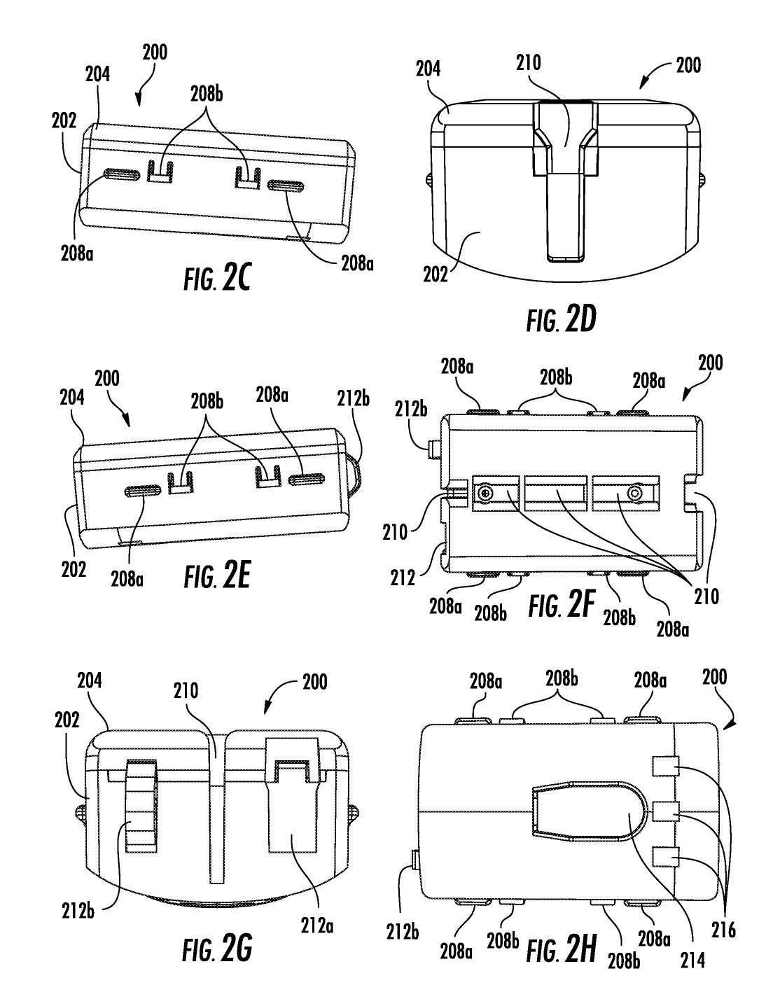

Referring now to FIGS. 2A-2G, the battery pack is shown generally at 200. The battery pack 200 includes a body portion 202 with a cover 204. One or more power cells 206 are included in the body portion 202 and wired electrically together, preferably in series. The body portion 202 includes a set of mating formations 208a, 208b configured and arranged for engagement with the adapter covers 302, 402, described below. A first set 208a is configured for a snap-fit engagement with either adapter cover 302, 402 and a second set 208b is configured as a top to prevent the battery pack 200 from being pushed through the adapter cover 302, 402, both of which will be describe in more detail below.

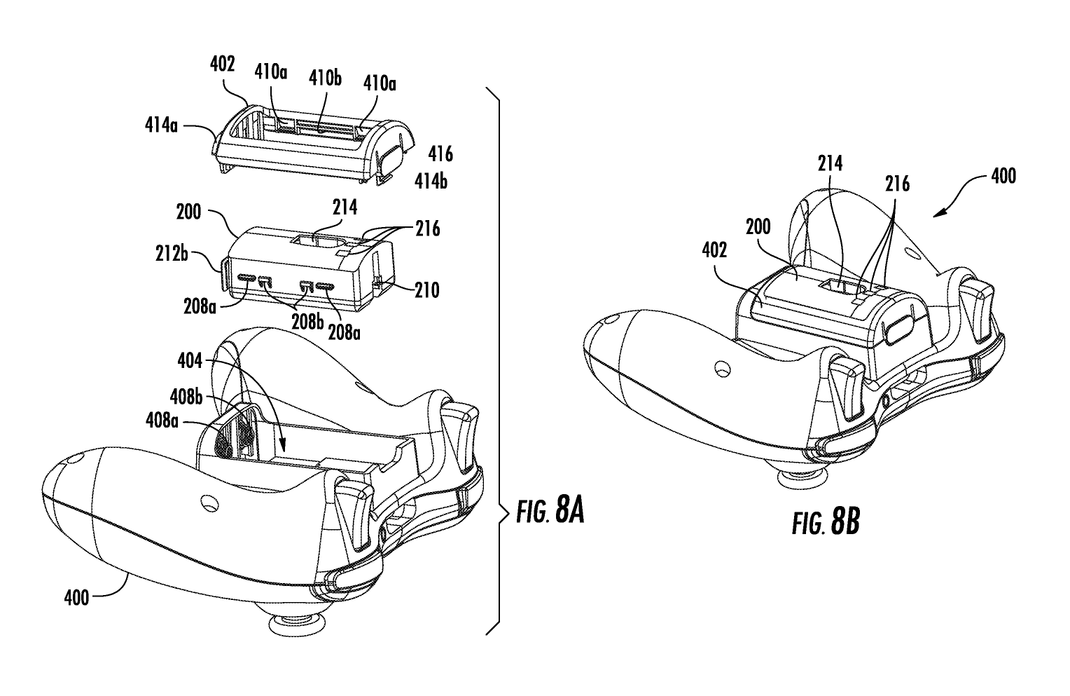

As seen in FIGS. 2D and 2F, the surface of the cover 204 and front and rear surfaces of the body portion 202 of the battery pack 200 includes a number of voids 210 to accommodate the shape of the battery compartment 30x, 40x in the game controllers 300, 400, examples of which can be seen in FIGS. 5A and 8A.

The rear face of the battery pack 200 includes a pair of electrical contacts 212a, 212b configured for engagement with the electrical contacts of a game controller to provide power from the power cells 206 to the game controller.

The bottom surface of the body portion 200, best seen in FIG. 2H, includes a recess 214 sized and dimensioned to receive the raised boss 114 on the cradle 102a, 102b of the charging station 100. One or more electrical contacts 216 are formed on the bottom surface of the body portion 202. The electrical contacts 216 are electrically connected to the powers cells 206 and configured for connecting to the electrical contacts 116 in the cradle 114.

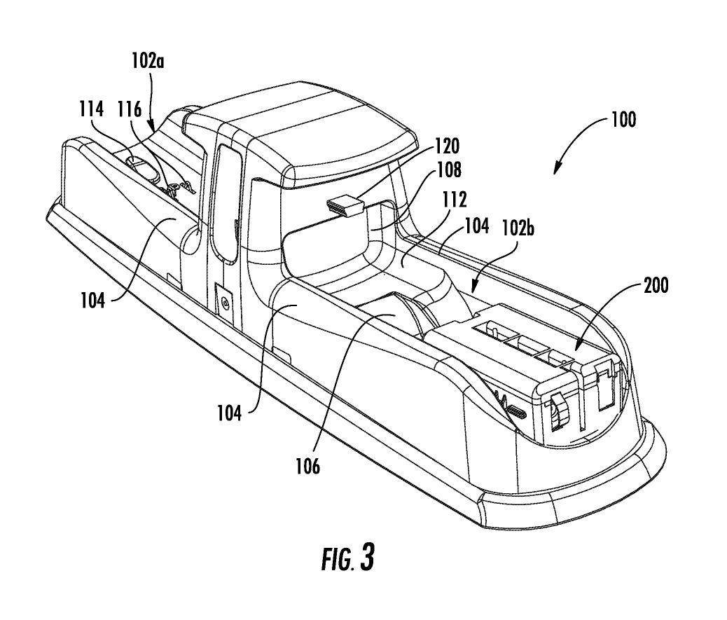

Referring now to FIG. 3, the battery pack 200 is shown docked in the cradle 102b of the charging station 100. The boss 114 in the cradle 102b mates with the recess 214 on the battery pack 200, ensuring that the electrical contacts 116 on the charging station 100 properly align with the battery electrical contacts 216 and preventing the battery pack 200 from being accidentally dislodged from the cradle 102b. Generally speaking, the battery packs 200 are intended to be charged while installed in the video game controller 300, 400 as described further below. However, the user may place a battery pack 200 in the charging station 100 for charging without being installed in a video game controller 300, 400.

Referring now to FIG. 4, a Sony brand video game controller 122, which lacks a removable battery pack, is shown docked in the charging station. The Sony brand video game controller 122 includes an integral battery (not shown). The charging station 100 may still charge the Sony brand video game controller 122 via the charging connector 120. The shape and contour of the cradle 102b permits the Sony brand video game controller 122 to be mounted in the cradle 102a because the sloped sides 104 conform to the bottom of the Sony brand video game controller 122. The Sony brand video game controller 122 may be placed in either cradle 102a, 102b.

Referring to FIGS. 5A and 5B, the battery pack 200 is mounted into a Nintendo brand video game controller 300 with a battery pack adapter cover 302. As can be seen, the battery pack 200 fits into the battery compartment 304 of the Nintendo brand video game controller 300. The voids 210 on the cover 204 and body portion 202 of the battery pack 200 accommodate plastic projections 306 inside the battery compartment 302. The electrical contacts 212a, 212b on the battery pack 200 engage electrical contacts 308a, 308b of the video game controller 300.

When coupled together, the adapter cover 302 and bottom surface of the battery pack 200 form a near uniform surface on the bottom of the Nintendo brand video game controller 300, excepting the recess 214 on the battery pack 200 that is configured to mate with the raised boss 114 in the cradle 102a, 102b of the charging station 100. The adapter cover 302 includes reciprocal mating formations 310a, 310b configured to engage the set of mating formations 208a, 208b on the battery pack 200.

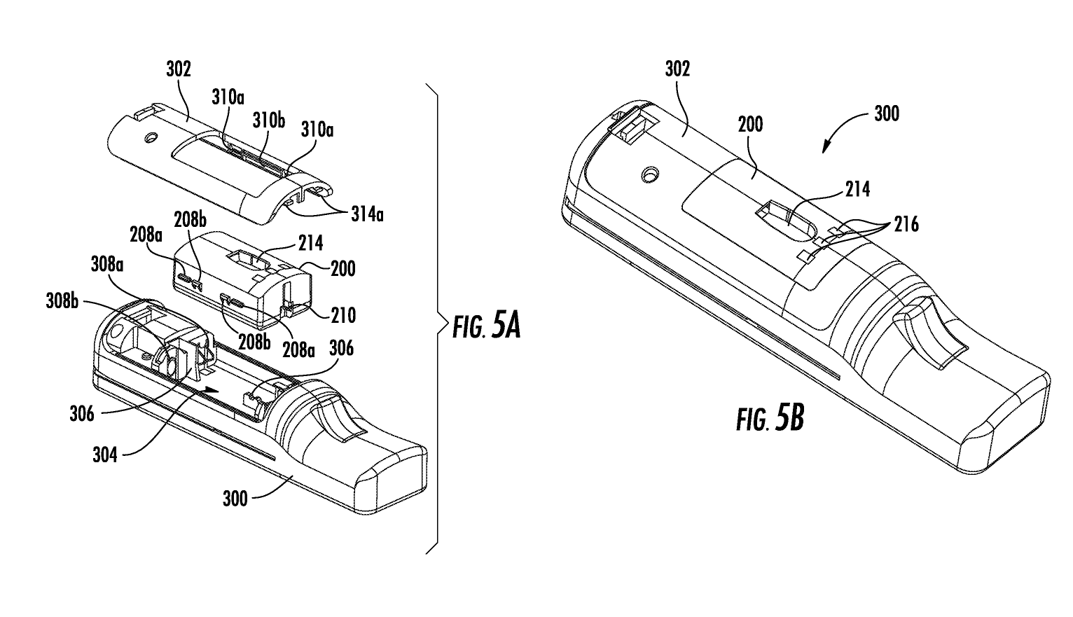

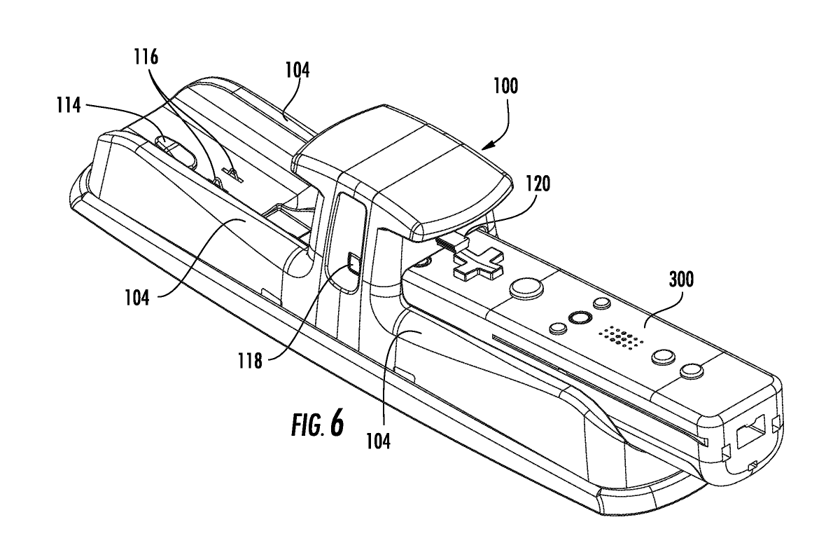

Referring now to FIG. 6, the Nintendo brand game controller 300 may be set into the charging station 100. The cradle 102b of the charging station 100 includes additional contours 106, 108, 110, 112 in the surface to accommodate the shape of the Nintendo brand video game controller 300. Moreover, the raised boss 114 engages the exposed recess 214 on the bottom of the battery pack 200 ensuring that the electrical contacts 216 of the battery pack 200 properly align with the electrical contacts 116 of the charging station 100.

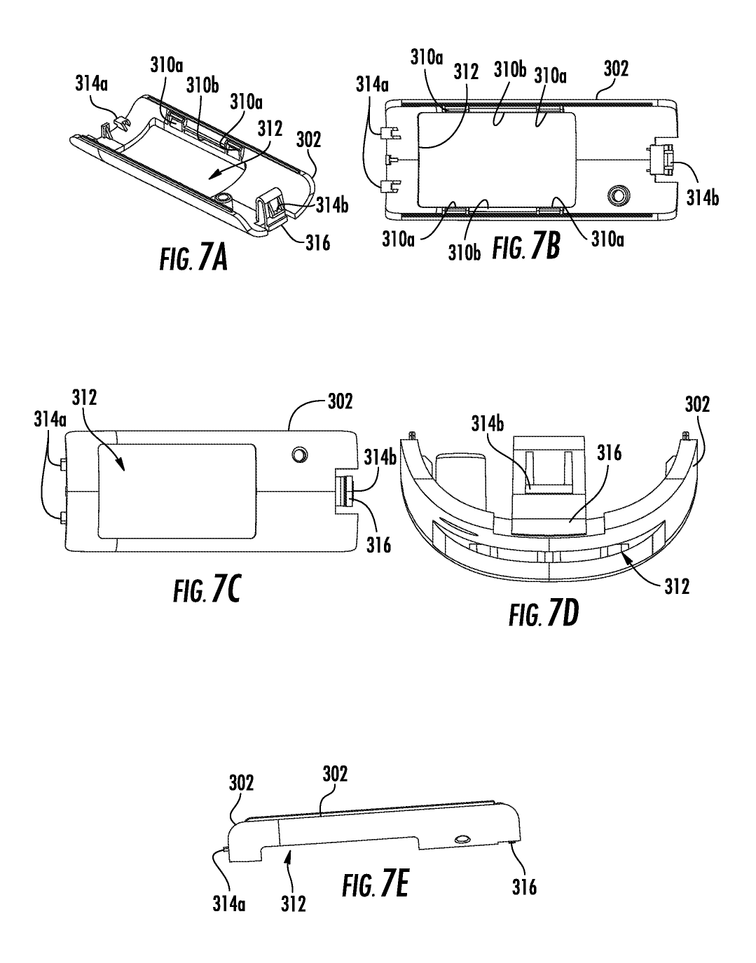

Referring now to FIGS. 7A-7E, the adapter cover 302 for the battery pack 200 for Nintendo brand video game controller 300 is shown generally. The adapter cover 302 includes an aperture 312 formed through the adapter cover 302, which exposes the bottom surface of the battery pack 200 when assembled therewith. The reciprocal mating formations 310a, 310b on the adapter cover snap-fit with the first set of mating formations 208a on the battery pack to prevent the adapter cover 302 from being easily separated from the battery pack 200. The second set of mating formations 208b on the battery pack 200 stop against the reciprocal mating formations 310b to prevent the battery pack 200 from being pushed entirely through the adapter cover 302.

The adapter cover 302 includes additional mating formations 314a, 314b at the front and rear of the adapter cover configured and arranged to engage the battery compartment 304 of the video game controller 300. The rear of the adapter cover 300 includes a release 316 to permit the adapter cover 302 to be removed and snapped into the battery compartment 304 of a video game controller easily 300.

Referring to FIGS. 8a and 8b, the battery pack 200 is mounted into a Microsoft brand video game controller 400 with a battery pack adapter cover 402. As can be seen, the battery pack 200 fits into the battery compartment 404 of the Microsoft brand video game controller 400. The voids 210 on the cover 204 and body portion 202 of the battery pack 200 are unnecessary inside the battery compartment 404 of the Microsoft brand video game controller 400. However, the adapter cover 402 includes additional electrical contacts 418a, 418b that engage the electrical contacts 212a, 212b on the battery pack 200. The additional electrical contacts 214a, 418b engage electrical contacts 408a, 408b of the video game controller 400 and thus form an electrical bridge between the battery pack 200 and the video game controller 400.

When coupled together, the adapter cover 402 and bottom surface of the battery pack 200 form a near uniform surface on the bottom of the Microsoft brand video game controller 400, excepting the recess 214 on the battery pack 200 that is configured to mate with the raised boss 114 in the cradle 122a, 102b of the charging station 100. The adapter cover 402 includes reciprocal mating formations 410a, 410b configured to engage the set of mating formations 208a, 208b on the battery pack 200.

Referring now to FIG. 9, the Microsoft brand game controller 400 may be set into the charging station 100. The cradle 102a of the charging station 100 includes additional contours in the surface 104, 110 to accommodate the shape of the Microsoft brand video game controller 400, battery adapter cover 402, and battery pack 200. Moreover, the raised boss 114 engages the exposed recess 214 on the bottom of the battery pack 200 ensuring that the electrical contacts 216 of the battery pack 200 properly align with the electrical contacts 116 of the charging station 100.

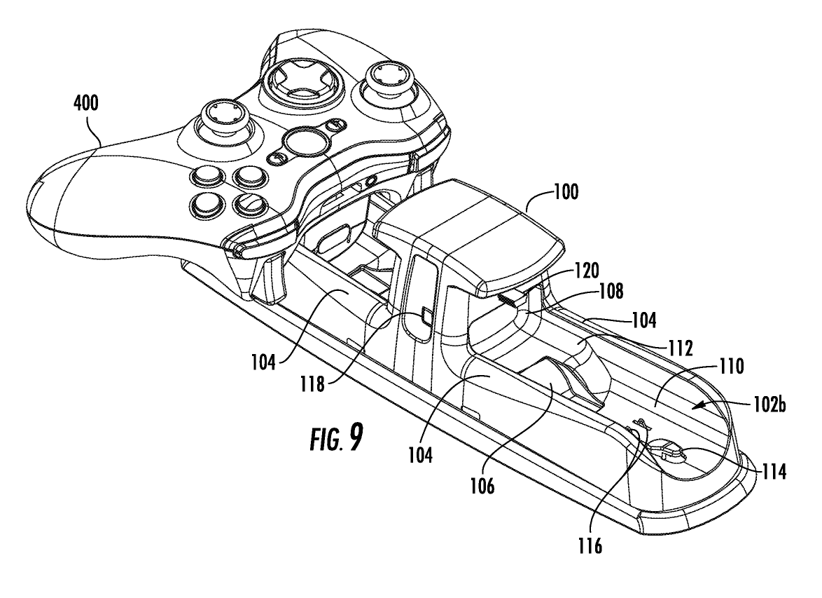

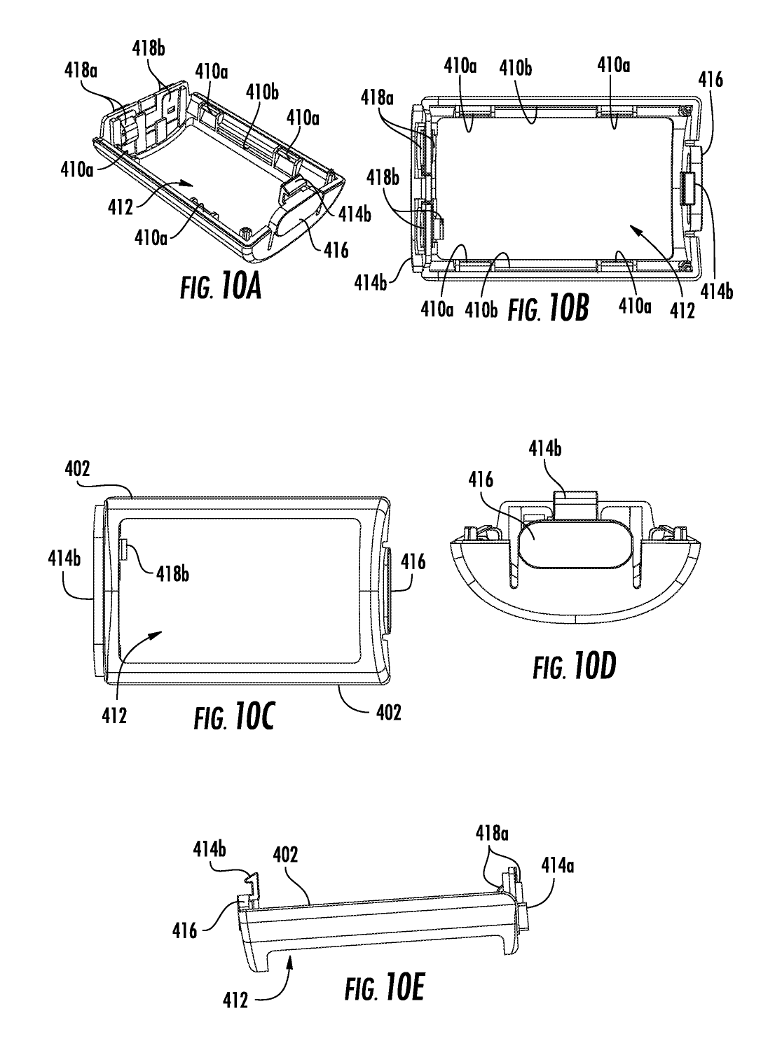

Referring now to FIGS. 10a-10g, the adapter cover 402 for the battery pack 200 for the Microsoft brand video game controller 400 is shown generally. The adapter cover 402 includes an aperture 412 formed through the adapter cover 402, which exposes the bottom surface of the battery pack 200 when assembled therewith. The reciprocal mating formations 410a on the adapter cover 402 snap-fit with the first mating formations 208a on the battery pack 200 to prevent the adapter cover 402 from being easily separated from the battery pack 200. The second set of mating formations 208b on the battery pack 200 stop against the reciprocal mating formations 410b to prevent the battery pack 200 from being pushed entirely through the adapter cover 402.

The adapter cover 402 includes additional mating formations 418a, 418b at the front and rear of the adapter cover 402 configured and arranged to engage the battery compartment 404 of the video game controller 400. The front of the adapter cover 402 includes a release 416 to permit the adapter cover 402 to be removed and snapped into the battery compartment 404 of a video game controller easily 400.

Therefore, it can be seen that the present invention provides a unique solution to the problem of providing a universal charging system and battery pack for multiple video game systems. Although the invention is described with reference to current popular brand video game systems, one skilled in the art would find adapting the present system to new or other brand video game systems easy.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. An interchangeable battery pack system for video game controllers, comprising:
a battery pack configured and arranged for insertion into a battery compartment of a video game controller, the batter pack having a bottom surface with a recess formed therein, the battery pack having a first set of battery electrical contacts for engagement with the electrical contacts of the video game controller and a second set of battery electrical contacts for charging the battery pack; and
a battery pack adapter cover configured and arranged to releasably attach to the battery pack, the battery pack adapter cover having an aperture therethrough exposing the bottom surface of the battery pack when attached thereto, the battery pack adapter cover having mating formation thereon configured and arranged to releasably attach to a battery compartment of a video game controller for a video game system.

2. The system of claim 1, further comprising a charging station having a cradle configured and arranged to charge the battery pack.

3. The system of claim 2, wherein the charging station includes a raised boss configured and arranged to engage the recess on the battery pack.

4. The system of claim 1, wherein the battery pack includes a set of mating formations and the battery pack adapter cover includes a reciprocal set of mating formations configured and arranged to snap-fit together.

5. The system of claim 1, wherein the aperture on the battery pack adapter cover is sized and dimensioned to expose the bottom surface of the battery pack only.

6. The system of claim 1, further comprising a video game controller.

7. The system of claim 6, wherein the video game controller is selected from the group consisting essentially of: Sony brand video game controller, Microsoft brand video game controller and Nintendo brand video game controller.

8. The system of claim 1, further comprising a second battery pack adapter cover configured and arranged to releasably attach to the battery pack, the second battery pack adapter cover having an aperture therethrough exposing the bottom surface of the battery pack when attached thereto, the battery pack adapter cover having mating formations thereon configured and arranged to releasably attach to a battery compartment of a video game controller for a different video game system.

9. The system of claim 8, further comprising another video game controller for a different video game system.

10. A universal charging system for a video game system, comprising:
a charging stand having a cradle, the cradle including a raised boss extending therefrom and a plurality of electrical contacts, the charging stand having a charging circuit electrically connected to the electrical contacts in the cradle configured and arranged to charge a battery pack; and
the cradle including a contoured surface configured and arranged to receive a variety of different shaped video game controllers therein in docking arrangement with the cradle for charging of a battery pack of the video game controller.

11. The system of claim 10, further comprising a charging connector electrically connected to the charging circuit.

12. The system of claim 11, wherein the charging connector is a mini-USB connector.

13. The system of claim 10, further comprising a battery pack configured and arranged for insertion into a battery compartment of a video game controller, the batter pack having a bottom surface with a recess formed therein, the battery pack having a first set of battery electrical contacts for engagement with the electrical contacts of the video game controller and a second set of battery electrical contacts for charging the battery pack.

14. The system of claim 13, further comprising a battery pack adapter cover configured and arranged to releasably attach to the battery pack, the battery pack adapter cover having an aperture therethrough exposing the bottom surface of the battery pack when attached thereto, the battery pack adapter cover having mating formation thereon configured and arranged to releasably attach to a battery compartment of a video game controller for a video game system.

15. The system of claim 10, further comprising a video game controller.

16. The system of claim 15, wherein the video game controller is selected from the group consisting essentially of: Sony brand video game controller, Microsoft brand video game controller and Nintendo brand video game controller.

17. A universal charging system for a video game system, comprising:
a charging stand having a cradle, the cradle including a raised boss extending therefrom and a plurality of electrical contacts, the charging stand having a charging circuit electrically connected to the electrical contacts in the cradle configured and arranged to charge a battery pack;
the cradle including a contoured surface configured and arranged to receive a variety of different shaped video game controllers therein in docking arrangement with the cradle for charging of a battery pack of the video game controller;
a battery pack configured and arranged for insertion into a battery compartment of a video game controller, the batter pack having a bottom surface with a recess formed therein configured and arranged to mate with the raised boss, the battery pack having a first set of battery electrical contacts for engagement with the electrical contacts of the video game controller and a second set of battery electrical contacts for charging the battery pack; and
a battery pack adapter cover configured and arranged to releasably attach to the battery pack, the battery pack adapter cover having an aperture therethrough exposing the bottom surface of the battery pack when attached thereto, the battery pack adapter cover having mating formation thereon configured and arranged to releasably attach to a battery compartment of a video game controller for a video game system.

18. The system of claim 17, further comprising a video game controller.

19. The system of claim 18, wherein the video game controller is selected from the group consisting essentially of: Sony brand video game controller, Microsoft brand video game controller and Nintendo brand video game controller.
